(19) United States
(12) Patent Application Publication
(10) Pub. No.: US 2007/0092614 A1
(43) Pub. Date: Apr. 26, 2007

(54) Method and apparatus for making bakery products

(76) Inventor: Clinton Scott Waldock, Queensland (AU)

Correspondence Address: Dilworth & Barrese, 333 Earle Ovington Blvd, Suite 702, Uniondale, NY, 11553, US

(21) Appl. No.: 10/567,896

(22) PCT Filed: Aug. 6, 2004
(86) PCT No.: PCT/AU04/01050

§ 371 Date: Aug. 16, 2006

(30) Foreign Application Priority Data
Aug. 8, 2003 (AU) 2003904176
Mar. 19, 2004 (AU) 2004901440

(51) Int. Cl. A23G 3/28

(52) U.S. Cl. 426/383

(57) ABSTRACT

The invention provides a method of marking bakery products including the steps of: mixing a bakery dough to make a bakery product; applying an ink to the bakery dough and baking the bakery dough to make the bakery product. The ink has a sufficiently low surface tension to prevent beading when applied to said bakery dough and comprises: glycerol between the percentages 0 to 60% by volume; solvent between the percentages 10 to 60% by volume; sucrose between the percentages 5 to 60% by volume; water between the percentages 1 to 55% by volume; and colouring agent between the percentages 0.5 to 20% by volume.

### FIELD OF THE INVENTION

This invention relates to a method and apparatus for marking bakery products. In particular, the invention relates primarily to the marking of biscuits for animals and humans. However, it should be appreciated that the method may be used for other bakery products such as breads, pastries or the like.

### BACKGROUND OF THE INVENTION

For many years biscuit manufacturers have been branding their biscuits so that consumers are able to recognise the type of biscuits they are consuming. This allows consumers to identify the biscuit and hopefully repurchase the biscuit if it is to their taste. It also allows manufactures to place other types of adverting material on their biscuits if the manufacturers so desire.

The most common method of branding biscuits is to cause valleys and ridges to be formed in the biscuit to provide viewable shapes, patterns, letters and/or words. The valleys and/or ridges are usually obtained by shaping biscuit dough prior to baking of the biscuits. The shaping of the biscuits is usually obtained by making a mould that has corresponding valleys and/or ridges located within the mould. Biscuit dough is pressed into the mould and when the dough is removed, the top of the biscuit dough has the associated valleys and/or moulds. The biscuit dough is then baked to form biscuits with desired markings.

There are several problems with marking biscuits using a mould. Firstly, the moulds are expensive to manufacture and can only be used to provide only that shape. Secondly, placing biscuit dough into the moulds is labour intensive and time consuming. Lastly, the shapes, patterns, letters and/or words formed on the biscuit are of the same colour biscuit as the other part of the biscuit. Therefore, the shapes, patterns, letters and/or words are often difficult to recognise. A consumer therefore has to make a conscious effort to look at the top of the biscuit to be able to read the shape, patterns, letters and/or words.

U.S. Pat. No. 4,670,271 describes an apparatus for and method of printing edible inks onto a transfer sheet such as paper, fabric, cellophane, polyethylene or other forms of plastic. The printed transfer sheet is then placed onto a cake. The transfer sheet is used to separate the ink and the cake, to prevent bleeding of the ink and spoiling the artwork.

GB 2,186,782 is similar to U.S. Pat. No. 4,670,271 in that it describes an ink composition of sucrose; water and dye, printed onto rice paper. This method is commonly referred to in the art as “copy printing”. These copy printing type processes involve a two step process, printing the transfer sheet and applying to the cake, thus making them rather time consuming.

U.S. Pat. No. 5,534,281 describes a high speed printing and cutting device for the production of cookies, crackers and the like. Whilst the specification describes a general method of continuously printing onto dough and prior to baking, the apparatus is not suitable for use with a broad range of commercially available inks as they are still subject to bleeding and deformation of the artwork, during the printing and/or baking steps.

Currently available apparatus and methods for printing or marking bakery products result in unattractive products due to bleeding of the inks.

### OBJECT OF THE INVENTION

It is an object of the invention to overcome or alleviate one or more of the above disadvantages or to provide the consumer with a useful or commercial choice.

### SUMMARY OF THE INVENTION

In one form, although not necessarily the broadest or only form, the invention resides in a method of marking bakery products including the steps of:

mixing a bakery dough to make a bakery product;

applying an ink to the bakery dough; and

baking the bakery dough to make the bakery product;

wherein the ink has a sufficiently low surface tension to prevent beading when applied to said bakery dough and comprises:

glycerol between the percentages 0 to 60 percent by volume;

solvent between the percentages 10 to 60 percent by volume;

sucrose between the percentages 5 to 60 percent by volume;

water between the percentages 1 to 55 percent by volume; and

colouring agent between the percentages 0.5 to 20 percent by volume.

The mixing of the bakery product may be completed by hand and/or using machinery.

The ink may be applied manually or automatically through the use of a machine. Preferably, the ink is applied to the bakery product using a stamp.

The bakery dough is normally baked in a conventional manner, that is, using an oven.

The method preferably utilises an ink comprising:
glycerol between the percentages 0 to 30 percent by volume;
solvent between the percentages 20 to 45 percent by volume;
sucrose between the percentages 5 to 35 percent by volume;
water between the percentages 10 to 35 percent by volume; and
colouring agent between the percentages 1 to 8 percent by volume.

The method more suitably utilises an ink comprising:
glycerol between the percentages 6 to 26 percent by volume;
solvent between the percentages 28 to 40 percent by volume;
sucrose between the percentages 9 to 30 percent by volume;
water between the percentages 15 to 30 percent by volume; and
colouring agent between the percentages 2.5 to 7.5 percent by volume.

The method may utilise an ink comprising;
26% glycerol,
39.5% solvent,
9% sucrose,
18% water, and
7.5% colouring agent.

Alternatively, the method may utilise an ink comprising;
6% glycerol,
32% solvent,
30% sucrose,
25% water, and
7% colouring agent.

In another alternative, the method may utilise an ink comprising;
20% glycerol,
28% solvent,
25% sucrose,
20% water, and
7% colouring agent.

In yet another alternative, the method may utilise an ink comprising;
20% glycerol,
28% solvent,
25% sucrose,
23.5% water, and
3.5% colouring agent.

The solvent is preferably an organic solvent. Solvents that may be used include ethanol, isopropyl alcohol, and propanol. Most preferably, the solvent is food-grade ethanol or isopropyl alcohol.

The colouring agent may vary depending on the desired colour of the ink. Suitable colouring agents include one or more pigments or dyes such as allura red 129, carbon black 153, sunset yellow 110, carmiosine 122, carmines 120, fast green 143, ponceau R4 124, tartrazine 102, brilliant blue 133, HT brown 155 and other similar colouring agents suitable for use in food products. The colouring agent may also comprise suitable solvents including water and food grade acids. Suitable food grade acids include formic acid, acetic acid, citric acid and the like.

### BRIEF DESCRIPTION OF THE DRAWINGS

Embodiments of the invention will be described, by way of example only, with reference to the accompanying drawings in which:

FIG. 1 is a combined hand stamp and cutter used to produce ink marked biscuits.

FIG. 2 is a photo comparison between biscuits marked using the method of the invention and biscuits marked using readily available edible inks.

### BRIEF DESCRIPTION OF PREFERRED EMBODIMENT

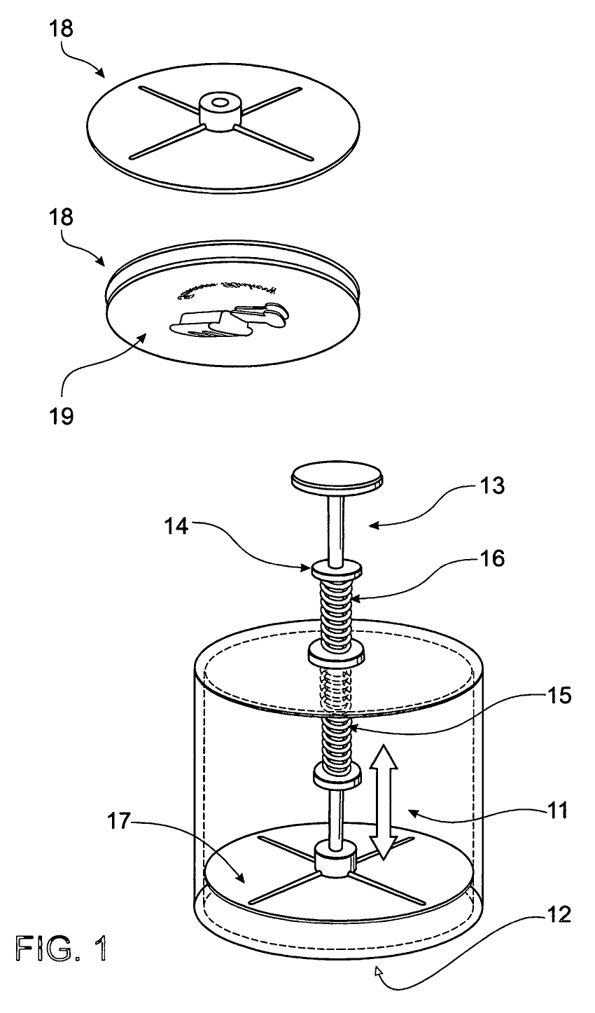

FIG. 1 shows a combined hand stamp and cutter 10 used to make biscuits. The hand stamp and cutter 10 has been combined so that biscuit dough can be cut to a desired shape and stamped at the same time.

### DETAILED DESCRIPTION

### Example 1

55 grams of carmiosine red pigment and 20 grams of ponceau R4 124 red pigment, 90 g sucrose is added to 180 mls of water and boiled until the carmiosine red and sucrose are dissolved. 260 mls of glycerol and 395 mls of ethanol is then added to form the following 1 litre of ink composition
26% glycerol
39.5% ethanol
9% sucrose
18% water and
7.5% colouring agent.

It will be readily appreciated by a person skilled in the art that solvents other than water may be used to dissolve the pigment or dye in the formation of the colouring agent will vary according to the pigment or dye being used. Other solvents may include appropriate food acids, such as formic acid.

Depending on the dye or pigment used in the formation of the ink the dye or pigment may be ground finely and suspended in the ink composition.

The percentage composition of ink outlined in Example 1 has been found to be effective for food grade red, blue and brown dye pigments.

### Example 2

In a similar manner to Example 1 ink was formed using brilliant blue dye pigment to create an ink comprising;
6% glycerol
32% ethanol
30% sucrose
25% water and
7% colouring agent.

### Example 3

In a similar manner to Example 1 ink was formed using HT Brown dye pigment to create an ink comprising;
20% glycerol
28% ethanol
25% sucrose
20% water and
7% colouring agent.

### Example 4

In a similar manner to Example 1 ink was formed using tartrazine dye pigment to create an ink comprising;
20% glycerol
28% ethanol
25% sucrose
23.5% water and
3.5% colouring agent.

It is preferable when forming inks comprising tartrazine as the colouring agent that the colouring agent is present in a concentration of between 2.5 to 4.5% to prevent the ink from becoming to viscose.

It will be appreciated by the person skilled in the art that a number of dye pigments may be used in the formation of a suitable ink in order to create a broad range of colours, e.g. combining brilliant blue and tartrazine to form a green colouring agent.

### Example 5

The combined stamp and cutter 10 includes a hollow cylindrical housing 11. A circular edge 12 of the housing is sharp and is used to cut biscuit dough into a circular shape. It should be appreciated that shape of the edge 12 may be changed to vary the shape of the biscuits.

A shaft 13 extends through the housing 11 substantially along a central axis of the housing 11. The shaft 13 is mounted to a top of the housing and is able to reciprocate with respect to the housing 11.

A stop 14 is located on the shaft to prevent the shaft from being reciprocated past a predetermined point. An internal spring 15 and an external spring 16 are mounted to the shaft locate the shaft 13 in a desired rest position.

A stamp 17 is located at the end of the shaft and is located within the housing 11. The stamp 17 comprises a backing plate 18 and a stamping plate 19. The backing plate 18 is attached to an end of the shaft 13 and is removably attached to the stamping plate 19. The stamping plate 19 is normally made of plastic or rubber. The stamping plate 19 is cut to reflect the desired impression to be placed on a biscuit.

To make a batch of marked biscuits, biscuit dough is mixed and rolled into a sheet of desired thickness. The ink of any one of the above examples is applied to the stamp plate 19 through the use of an inkpad (not shown). The combined stamp plate 19 and cutter 10 is located over the inkpad and the top of the shaft 13 is pushed toward the top of the housing 11 until the stamping plate 19 contacts the inkpad. The shaft 13 is released and returns to the rest position.

The combined stamp and cutter 10 is placed on the sheet of biscuit dough and force is again applied to the shaft 13. This causes the stamping plate 19 to contact the biscuit dough and apply ink to the biscuit dough. At the same time, the edge 12 of the housing 11 cuts the biscuit dough to produce an image. This process is repeated until all the biscuit dough is cut. The biscuit dough is then baked to produce the batch of biscuits.

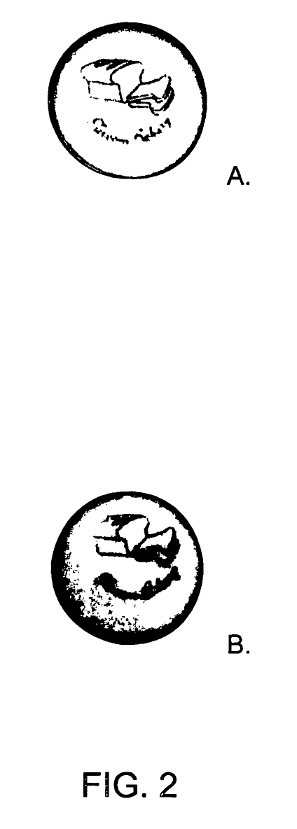

FIG. 2 show a comparison of a biscuit dough stamped using the method of the invention in a similar manner to that described in Example 5 (A), compared with biscuit dough stamped with commercially available inks using a hand stamp (B). It can be readily seen that the method of the invention provides a printed biscuit that has a clear image and can convey fine detail. Whilst the printing using commercially available ink results in bleeding of the ink to the extent that detail of the image is lost thorough the ink bleeding over the biscuit.

The method of the invention and the ink used within the method provides the advantage that when applied to the biscuit dough, the ink does not bleed into the biscuit dough and hence a clear, crisp image can be produced on the biscuit. Further, the ink is not affected by baking and does not burn. The application of ink allows a quick and efficient image to be placed on a biscuit. Different colours can be used to create a more noticeable image.

It has found that by altering the solvent; glycerol; water content of a commercially available ink that surprising improvements in quality and appearance of marking or printing on bakery products can be achieved. It is believed that currently available edible inks bleed when printing onto bakery products because on initial application the ink beads, as it settles into the bakery product the bead spreads to cause a disperse area of colouring, or bleeding. It has surprisingly been found that by increasing the ethanol and glycerol contents of commercially available edible inks compositions to create inks which have a surface tension which is sufficiently low to prevent beading of the ink on application to bakery product, thus preventing bleeding and allowing the producing of a printed or marked product having a clear and image, patter, words and/or letters.

The method of the invention provides greater flexibility to a baker in that with the method of the invention they may now clearly printing or marking a broad range of bakery products, including the pastry crust of pies, bread rolls and loaves, shortcrust etc. Prior to the development of the method of the invention it was not possible to produce a clear printed or marked bread roll or loaf, without scorching the image onto the roll or loaf that affected the taste of the bread. Furthermore, a broad range of printing apparatus may be utilised to in the method of the invention.

It should be appreciated that the ink may be applied to the biscuit dough using any number of different methods. For example, a self-inking stamp and cutter may be used so that the inkpad is unnecessary. Alternatively, the biscuit dough may be cut separately and a separate stamp used to apply the ink to the biscuit dough. Still alternatively, the ink may be used with an automatic baking machine in which the ink is applied in an automated fashion.

The bakery product may be printed using a roller stamping method, a mechanical stamping method, stencil spraying and/or laser and ink jet printing techniques. The stamping surface may be selected from gun metal, brass, cast steel, natural rubber, synthetic rubber, and food grade elastomeric materials.

It is anticipated that if the above method employs a laser jet or ink jet printing apparatus it may be necessary lower the glycol content to less than 1% of the ink. The glycerol is required help the dye pigment to dry as a thin film but needs to be in sufficiently low concentrations to prevent fouling of the printing head. Without the glycerol the dye pigment dries as a powder during baking of the bakery product.

It will be appreciated by the person skilled in the art that the ink compositions described above may be altered or customised within the defined ranges to suit the various printing techniques, apparatus or stamp surfaces that may be utilised to apply the ink to a bakery product prior to baking.

The methods and inks described above may also be applied to bakery products for animal consumption, such as dog and cat biscuits.

It should be appreciated that various other changes and modifications may be made to the invention described without departing from the spirit or scope of the invention.

1. A method of making bakery products including the steps of:
mixing a bakery dough to make a bakery product;
applying an ink to the bakery dough product; and
baking the bakery dough to make the bakery product;
wherein the ink has a sufficiently low surface tension to prevent beading when applied to said bakery dough and comprises:
glycerol between the percentages 0 to 60 percent by volume;
solvent between the percentages 10 to 60 percent by volume;
sucrose between the percentages 5 to 60 percent by volume;
water between the percentages 1 to 55 percent by volume; and
colouring agent between the percentages 0.5 to 20 percent by volume.

2. The method of claim 1, wherein the ink is applied manually to the bakery product.

3. The method of claim 1, wherein the ink is applied automatically through the use of a machine.

4. The method of claim 3, wherein the ink is applied to the bakery product using a stamp.

5. The method of claim 4, wherein the stamp is selected from a hand held manual stamp, a roller stamp, or an automated mechanical stamp.

6. The method of claim 3, wherein the ink is applied to the bakery product using stencil spraying.

7. The method of claim 3, wherein the ink is applied to the bakery product using an ink jet or laser-printing device.

8. The method of claim 1, wherein the solvent is selected from ethanol, isopropyl alcohol, and propanol.

9. The method of claim 1, wherein the colouring agent comprises a one or more dye pigments selected from allure red 129, carbon black 153, sunset yellow 110, carmiosine 122, ponceau R4 124, carmines 120, fast green 143, tartrazine, brilliant blue 133, HT brown, and the like.

10. The method of claim 1, wherein the ink comprises:
glycerol between the percentages 0 to 30 percent by volume;
solvent between the percentages 20 to 45 percent by volume;
sucrose between the percentages 5 to 35 percent by volume;
water between the percentages 10 to 35 percent by volume; and
colouring agent between the percentages 1 to 8 percent by volume.

11. The method of claim 10, wherein the ink comprises:
glycerol between the percentages 6 to 26 percent by volume;
solvent between the percentages 28 to 40 percent by volume;
sucrose between the percentages 9 to 30 percent by volume;
water between the percentages 15 to 30 percent by volume; and
colouring agent between the percentages 2.5 to 7.5 percent by volume.

12. The method of claim 1, wherein the ink comprises:
26% glycerol,
39.5% solvent,
9% sucrose,
18% water, and
7.5% colouring agent.

13. The method of claim 1, wherein the ink comprises:
6% glycerol.
32% solvent,
30% sucrose,
25% water, and
7% colouring agent.

14. The method of claim 1, wherein the ink comprises:
20% glycerol.
28% solvent,
25% sucrose,
20% water, and
7% colouring agent.

15. The method of claim 7, wherein the ink comprises less than 1% glycerol.
